(19) United States
(12) Patent Application Publication
(10) Pub. No.: US 2007/0002531 A1
(43) Pub. Date: Jan. 4, 2007

(54) Mounting and release mechanism for a mobile communication device

(76) Inventors: Michael S. Beard, Boca Raton, FL (US); Juan B. Delaluz, Miami, FL (US); Donald F. Gatto, Coral Springs, FL (US); David H. McClintock, Davie, FL (US); Andreas Haase, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/172,196

(22) Filed: Jun. 30, 2005

(51) Int. Cl. G06F 1/16

(52) U.S. Cl. 361/685

(57) ABSTRACT

An apparatus (100) for installation and removal of a mobile communication device (102) to and from a bracket (104), such as mounted in a vehicle, is provided. The apparatus (100) includes a handle (120) pivotably coupled (160) to the mobile communication device (102), the handle having first and second lever arms (122, 124). The apparatus (100) further includes a bracket (104) having first and second pivot point pins (130, 132) and a compliant member (144). During installation the handle (120) is pivoted in a first direction such that the first and second lever arms (122, 124) engage the first and second pivot point pins (130, 132), and the handle compresses the mobile communication device (102) into the compliant member (144) for retention. The lever arms (122, 124) disengage the pivot point pins (130, 132) as the handle (120) is pivoted in an opposite direction thereby releasing the mobile communication device (102) from the bracket (104).

### TECHNICAL FIELD

This invention relates in general to mobile communication devices and more specifically to mounting and release mechanisms used in conjunction with such devices.

### BACKGROUND

Mobile communication devices, such as high power radios and data terminals, typically require a mounting bracket to secure the device to a vehicle. The mounting bracket used must be able to hold the device chassis in a secure manner during all transient environments, including vibration and mechanical shock, making environmental factors important considerations of the design. Installation, removal and handling are also important parameters to be considered when designing the mounting and release mechanism for a mobile communication device. Installation and removal of the device to and from the bracket can be cumbersome and awkward for an installer when space constraints within the vehicle are limited. Also, peripheral components, such as cables and locks, connected to the mobile communication device can get in the way or require being removed during the installation and/or removal process. Tools are often required for installation and removal of the device and/or its peripherals which increases assembly complexity and time.

Accordingly, it would be beneficial to have an improved mounting and release mechanism for a mobile communication device.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 shows an apparatus for installation and removal of a mobile communication device to/from a bracket in accordance with the present invention;

FIGS. 2 and 3 show partially cut-away views of the mobile communication device within the bracket with the handle pivoted in two different positions in accordance with the present invention; and

FIG. 4 shows the apparatus formed in accordance with the present invention in with peripheral components attached thereto.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below. It is further understood that the use of relational terms, if any, such as first, second, top and bottom, front and rear and the like are used solely for distinguishing one entity or action from another, without necessarily requiring or implying any such actual relationship or order between such entities or actions.

Briefly, there is provided herein an apparatus for installation and removal of a mobile communication device to and from a bracket, such as coupled to a vehicle. The apparatus includes a handle pivotably coupled to the mobile communication device, the handle engaging, retaining and disengaging the mobile communication device to and from the bracket.

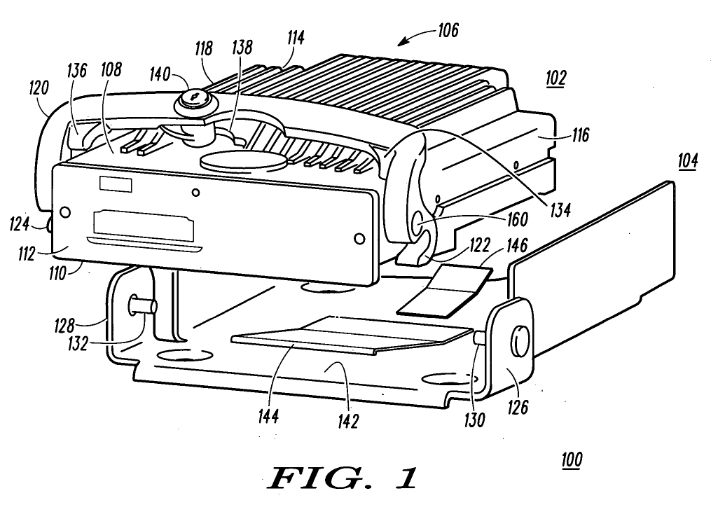

FIG. 1 shows an apparatus 100 for installation and removal of a mobile communication device 102 to/from a bracket 104 in accordance with the present invention. Mobile communication device 102 is formed of a chassis 106 having top, bottom, front and rear surfaces and first and second sides 108, 110, 112, 114, 116, 118 respectively. In accordance with the present invention, mobile communication device 102 includes a handle 120 pivotably coupled 160 to the first and second sides 116, 118 of the chassis 106, the handle including first and second side lever arms 122, 124.

In accordance with the present invention, bracket 104 includes first and second side appendages 126, 128 with pivot point pins 130, 132 protruding inward therefrom. In accordance with the present invention, the bracket 104 further includes at least one compliant member 144. For the apparatus 100 shown in FIG. 1, two compliant members are shown 144, 146. Compliant members 144, 146 are shown here as cantilevered springs coupled to and deflecting from the bracket's bottom surface 142. Other compliant member(s), such as coil springs, foam pads or the like could also be used. In accordance with the present invention, apparatus 100 allows mobile communication device 102 to be slid in, retained and slid out of bracket 104.

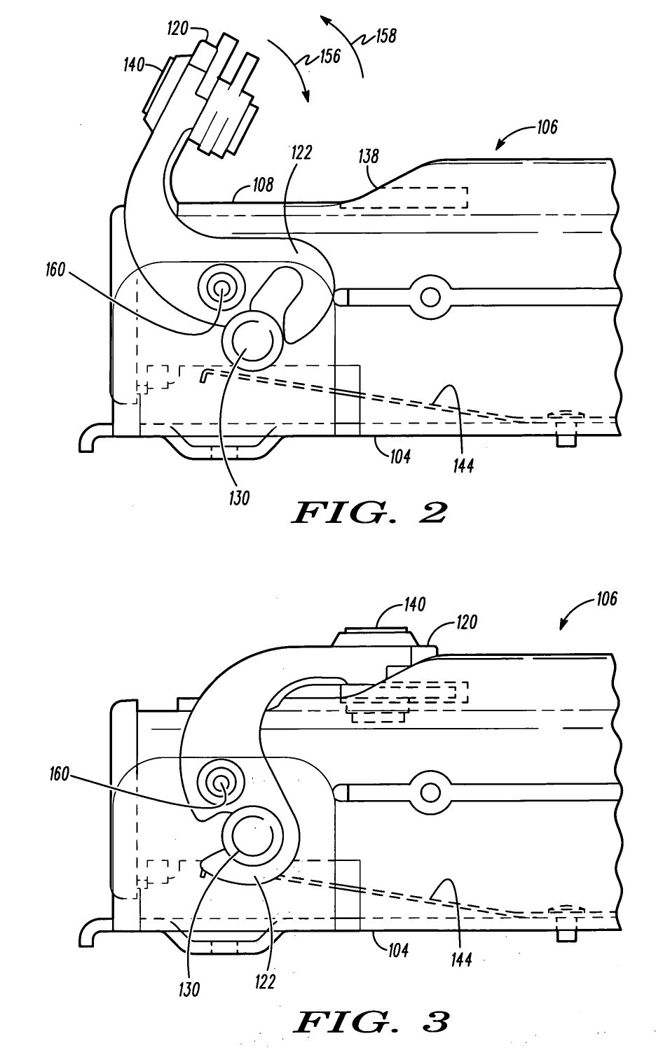

Referring now to FIGS. 2 and 3 there are shown partial cut-away views of the mobile communication device 102 within bracket 104 with the handle 120 pivoted in two different positions in accordance with the present invention. In accordance with the present invention, the first and second lever arms 122, (124 opposite side) of the handle 120 engage the first and second pivot point pins 130, (132 opposite side) as the handle 120 is pivoted in a first direction 156 towards the top surface 108 of chassis 106. As the handle 120 is pivoted in the first direction 156, the chassis 106 compressibly couples to the compliant member 144. The relative location of the pivot point pins 130, (132 opposite side) and handle 120 provide a low insertion force advantage for the lever arms 122, 124 compared to the retention force provided during subjection to environmental stress. Compliant member 144 provides a force in the opposite direction of the pivot point for further engagement of mobile communication device 102 within bracket 104.

In accordance with the present invention, the lever arms 122, 124 disengage from the pivot point pins 130, (132 opposite side) as the handle 120 is pivoted in an opposite direction 158, clearing the top surface 108 of the chassis 106. During rotation of the handle 120 in the opposite direction 158, a pair of stops 134, 136 (seen in FIG. 1) limit the motion of the handle from coming back down onto the chassis' top surface 108. The first and second stops 134, 136 maintain the handle 120 at a predetermined angle relative the top surface 108 of the chassis 106. The predetermined angle is preferably selected to provide sufficient space for a user's hand to grab the handle. The communication device 102 is thus released and can be pulled and slid out of the bracket 104 using the handle 120.

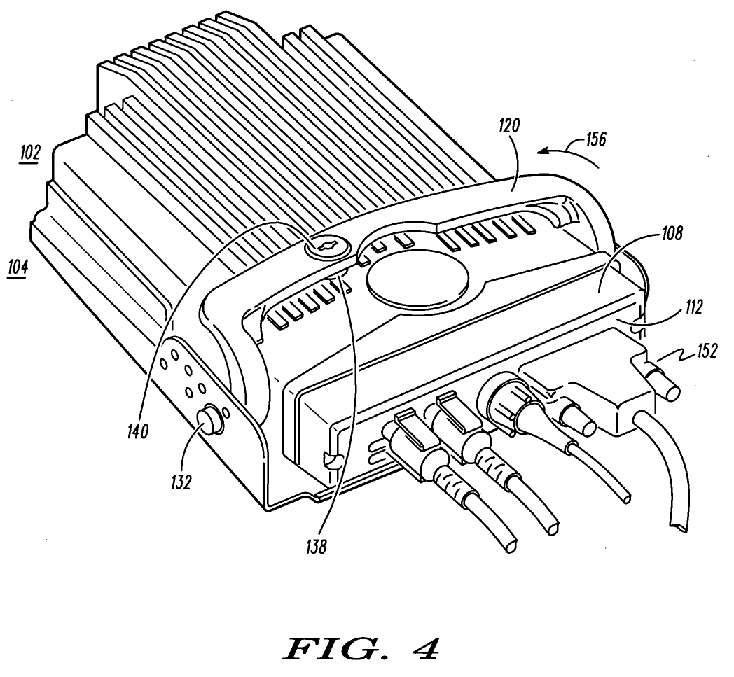

As seen in FIG. 4, limiting the travel of the handle 120 allows a higher density of peripheral components (connecters/controls) 152 to be connected at the most accessible location of the mobile communication device 102—the front surface 112. These peripheral components 152 can remain connected to the mobile communication device 102 during installation and removal procedures thereby providing a significant advantage over existing systems.

As an extra security feature, and as seen in FIGS. 1-4, a lock or latch 140 can be provided to the apparatus 100 to prevent removal of the communication device 102 from the bracket 104. Lock 140 is preferably included within a top surface of the handle 120. To accommodate lock 140, a recess 138 is preferably formed within the top surface 108 of the chassis 106. Recess 138 receives the lock 140 as the handle is pivoted in a first direction 156 towards the top surface 108 of chassis 106. The lock 140 is engaged by rotating the lock's tab such that the tab is retained within recess 138. Thus, lock 140 retains the handle 120 against the top surface 108 of the chassis 106 while the bracket's pivot point pins 130, 132 are engaged within lever arms 122, 124 thereby preventing removal of the communication device 102 from the bracket 104. Locating the lock 140 on the top of the handle 120 within recess 138 minimizes the load on the lock tab.

Accordingly, there has been provided an apparatus for installation and removal of a mobile communication device to and from a bracket. The apparatus is particularly useful in vehicular environments subjected to high transient environments and tight spacing requirements. The apparatus formed in accordance with the present invention allows a mobile device to be installed and removed by pivoting a handle configured with engagement capabilities as well as a predetermined range of motion within a bracket having retention features. The slide-in, slide out capability in the horizontal plane allows vertical clearances to be minimized. Since no tools are required, the installation and removal process has been greatly simplified over previous mounting mechanisms.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An apparatus for installation and removal of a mobile communication device having a chassis with top, bottom, first and second sides and front and rear surfaces, the apparatus comprising:
a handle pivotably coupled to the first and second sides of the chassis, the handle including first and second side lever arms;
a bracket for receiving the chassis, the bracket having first and second pivot point pins and a compliant member; and
wherein the first and second lever arms of the handle engage the first and second pivot point pins as the handle is pivoted in a first direction thereby compressibly coupling the chassis to the compliant member of the bracket, the lever arms disengaging the pivot point pins as the handle is pivoted in an opposite direction thereby releasing the chassis from the bracket.

2. The apparatus of claim 1, wherein the handle includes first and second stops for limiting motion of the handle to the top surface of the chassis.

3. The apparatus of claim 1, further comprising:
a recess formed within the top surface of the chassis; and
a lock coupled to the handle, the lock being received within the recess when the handle is pivoted in the first direction, the lock latching the handle to the top surface of the chassis thereby preventing removal of the communication device from the bracket.

4. The apparatus of claim 1, further comprising peripheral components coupled to the front surface of the chassis, the peripheral components remaining coupled to the chassis during installation and removal of the chassis from the bracket.

5. The apparatus of claim 2, wherein the first and second stops limit the motion of the handle to a predetermined angle relative to the top surface of the chassis, the predetermined angle providing sufficient space for a user's hand to grab the handle.

6. The apparatus of claim 1, wherein the compliant member provides a force in the opposite direction of the first pivot direction for further engagement of the mobile communication device within the bracket.

7. The apparatus of claim 6, wherein the first and second compliant members comprise first and second cantilevered springs.

8. An apparatus for a mobile communication device in a vehicle, comprising:
a bracket mounted to the vehicle for receiving the mobile communication device, the bracket including first and second pivot point pins and a compliant member;
a handle pivotably coupled to the mobile communication device, the handle including first and second lever arms for engaging the first and second pivot point pins of the bracket with a first pivot rotation of the handle, the first pivot rotation of the handle also compressibly coupling the mobile communication device to the compliant member of the bracket; and
the handle disengaging the mobile communication device from the bracket with an opposite pivot rotation.

9. The apparatus of claim 8, further comprising a lock coupled to the handle, the lock locking the communication device within the bracket.

10. The apparatus of claim 8, further comprising a stop feature coupled to the handle for limiting a range of motion for the handle relative to the mobile communication device.

11. The apparatus of claim 8, wherein the compliant member provides a force in the opposite direction of the first pivot direction.

12. An apparatus for installation and removal of a mobile communication device to and from a bracket, comprising:
a handle pivotably coupled to the communication device;
a bracket including a compliant member and pivot point pins; and
the handle engaging the mobile communication device to the bracket via the pivot point pins and the compliant member, and the handle disengaging the mobile communication from the bracket via the pivot point pins.

13. The apparatus of claim 12, wherein rotation of the handle in a first direction engages the mobile communication device to the bracket.

14. The apparatus of claim 13, wherein rotation of the handle in an opposite direction disengages the mobile communication device from the bracket.

15. The apparatus of claim 12, further comprising a lock for locking the handle to the mobile communication device thereby locking the mobile communication device within the bracket.

16. The apparatus of claim 12, further comprising a stop feature coupled to the handle for limiting a range of motion of the handle relative to the mobile communication device.

17. The apparatus of claim 16, wherein the range of motion of the handle is limited to a predetermined angle providing sufficient clearance for a user's hand to grab the handle.
